(19) United States
(12) Patent Application Publication
(10) Pub. No.: US 2009/0328102 A1
(43) Pub. Date: Dec. 31, 2009

(54) Representative Scene Images

(75) Inventors: Ronald A. Morris, Seattle, WA (US); David H. Sloo, Menlo Park, CA (US); Gionata Mettifogo, Menlo Park, CA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/146,651

(22) Filed: Jun. 26, 2008

(51) Int. Cl. H04N 5/445

(52) U.S. Cl. 725/41

(57) ABSTRACT

Representative scene images are described. In embodiment(s), an episodes user interface can be generated to include scene images that each represent and visually distinguish a different episode in a television program series. The episodes user interface can then be communicated to a media device to be rendered for display where the scene images are viewer-selectable via the episodes user interface. A scene image can be selected to initiate a request for an episode in the television program series to be rendered for viewing at the media device.

### BACKGROUND

Viewers have an ever-increasing selection of media content to choose from, such as television programming, movies, videos, and music that is available for selection and viewing. In addition to scheduled television program broadcasts, television viewing options also include on-demand choices which enable a viewer to search for and request recorded media content for viewing when convenient rather than at a scheduled broadcast time. Given the large volume of the various types of media content to choose from, viewers may want to be able to locate media content that is of interest to them from a more intuitive type of selection utility than a conventional grid-based program guide that lists television programming by time and channel.

Various media devices, such as televisions, personal media players, mobile phones, portable video games, computer devices, and the like can all have the capability to acquire and playback or render movies, television programs, photos, and music from various private and public networks, as well as from proprietary marketplaces. It is increasingly commonplace to find more television video content, music videos, and images that can be viewed on almost any media device that has a display screen. Further, it is quite likely that one person may own several of the various media devices. Having a variety of different media devices, however, can make it difficult for a user of multiple devices to navigate, find, and play or render the different types of media content because most of the different media devices on the market today have a unique interface.

### SUMMARY

This summary is provided to introduce simplified concepts of representative scene images. The simplified concepts are further described below in the Detailed Description. This summary is not intended to identify essential features of the claimed subject matter, nor is it intended for use in determining the scope of the claimed subject matter.

Representative scene images are described. In embodiment(s), an episodes user interface can be generated to include scene images that each represent and visually distinguish a different episode in a television program series. The episodes user interface can then be communicated to a media device to be rendered for display where the scene images are viewer-selectable via the episodes user interface. A scene image can be selected to initiate a request for an episode in the television program series to be rendered for viewing at the media device.

In other embodiment(s), a scene image in an episodes user interface can include a visual context that is identifiable to represent what an episode in the television program series is about. Alternatively or in addition, a scene image can include a textual description of an episode in the television program series, such as a title of the episode. Alternatively or in addition, a scene image can include a progress indicator that indicates how much of an episode in the television program series has been rendered for viewing at a media device. In another embodiment, a scene image of the episode in the television program series can be replaced with a suspended image that represents where a rendering of the episode is paused or stopped at the media device. In another embodiment, an episodes user interface can be generated to include scene images that each visually indicate a viewing status of the different episodes in the television program series at the media device.

### BRIEF DESCRIPTION OF THE DRAWINGS

Embodiments of representative scene images are described with reference to the following drawings. The same numbers are used throughout the drawings to reference like features and components:

FIG. 1 illustrates an example system in which embodiments of representative scene images can be implemented.

FIG. 2 illustrates another example system in which embodiments of representative scene images can be implemented.

FIG. 3 illustrates example method(s) for representative scene images in accordance with one or more embodiments.

FIG. 4 illustrates example method(s) for representative scene images in accordance with one or more embodiments.

FIG. 5 illustrates various components of an example device that can implement embodiments of representative scene images.

### DETAILED DESCRIPTION

Embodiments of representative scene images provide that the episodes in a television program series can each be represented and visually distinguished by scene images that are included in an episodes user interface. The scene images can be generated as representative icons that each convey what an episode in the television program series is about to help make media content selections easier to locate for a viewer. An episodes user interface can be displayed at a media device, such as a television client device, and the scene images are viewer-selectable via the episodes user interface. A scene image can be selected to initiate a request for an episode to be rendered for viewing at the media device. From the scene images in an episodes user interface, a viewer can see what each individual episode of the television program series is about, where a television episode was stopped or paused, and what programs are playing on other media devices.

In various embodiments, a scene image can include a visual context that is identifiable to represent what an episode in a television program series is about. A scene image can also include a textual description of a television episode, such as a title of the program. A scene image can also include a progress indicator that indicates how much of a television episode has been rendered for viewing at a media device. In another embodiment, a scene image of a television episode can be replaced with a suspended image that represents where a rendering of the episode is paused or stopped at the media device. In another embodiment, an episodes user interface can be generated to include scene images that each visually indicate a viewing status of the different episodes in the television program series at a media device.

While features and concepts of the described systems and methods for representative scene images can be implemented in any number of different environments, systems, and/or various configurations, embodiments of representative scene images are described in the context of the following example systems and environments.

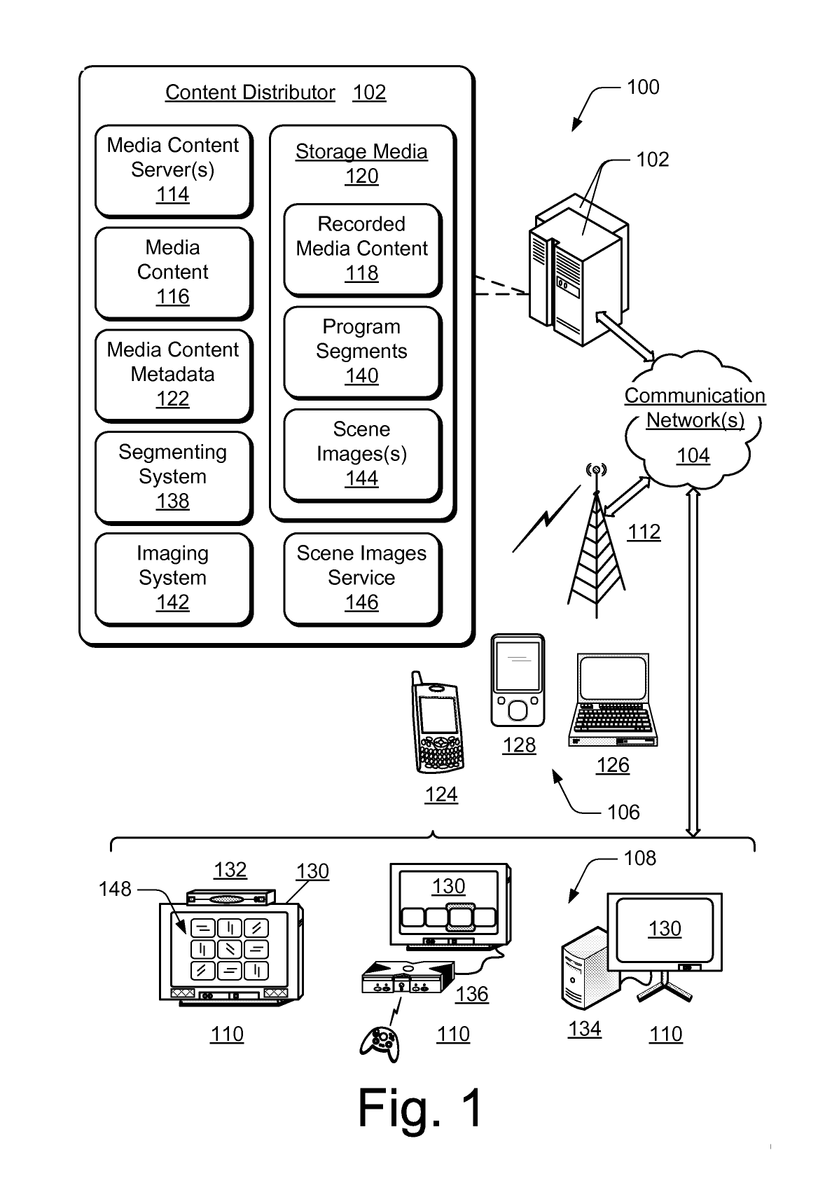

FIG. 1 illustrates an example system 100 in which various embodiments of representative scene images can be implemented. In this example, system 100 includes one or more content distributors 102 that communicate or otherwise provide media content to any number of various media devices via communication network(s) 104. The various media devices can include wireless media devices 106 as well as other media devices 108 (e.g., wired and/or wireless client devices) that are implemented as components in various client systems 110. In a media content distribution system, the content distributors 102 facilitate the distribution of media content, content metadata, and/or other associated data to multiple viewers, users, customers, subscribers, viewing systems, and devices.

The communication network(s) 104 can be implemented to include any type of data network, voice network, broadcast network, an IP-based network, a wide area network (e.g., the Internet), and/or a wireless communications network 112 that facilitates media content distribution, as well as data and/or voice communications between the content distributors 102 and any number of the various media devices. The communication network(s) 104 can also be implemented using any type of network topology and/or communication protocol, and can be represented or otherwise implemented as a combination of two or more networks. Any one or more of the arrowed communication links facilitate two-way communications, such as from the content distributor 102 to a media device 108 (e.g., a television client device) and vice-versa.

The content distributor 102 can include media content servers 114 that are implemented to receive television media content for distribution to subscriber media devices. The content distributor 102 can receive media content 116 from various content sources, such as a content provider, an advertiser, a national television distributor, and the like. The content distributor 102 can communicate or otherwise distribute media content 116 and/or other data to any number of the various wireless media devices 106 and other media devices 108.

The media content 116 (e.g., to include recorded media content 118) can include any type of audio, video, and/or image media content received from any type of media content source. As described throughout, “media content” can include television programs (or programming), advertisements, commercials, music, movies, video clips, and on-demand media content. Other media content can include interactive games, network-based applications, and any other audio, video, and/or image content (e.g., to include program guide application data, user interface data, advertising content, closed captions data, content metadata, search results and/or recommendations, and the like).

In the example system 100, the content distributor 102 includes storage media 120 to store or otherwise maintain various data and media content, such as media content 116, recorded media content 118, media content metadata 122, and/or subscriber information. In a Network Digital Video Recording (nDVR) implementation, recorded on-demand assets and media content can be recorded when initially distributed to the various media devices as scheduled television media content, and stored with the storage media 120 or other suitable storage device. The storage media 120 can be implemented as any type of memory, random access memory (RAM), read only memory (ROM), any type of magnetic or optical disk storage, and/or other suitable electronic data storage.

The media content metadata 122 can include any type of identifying criteria, descriptive information, and/or attributes associated with the media content 116 that can describe and categorize the media content. The metadata 122 that is associated with a television program, movie, or advertisement can be any form of information that describes and/or characterizes the media content. For example, metadata can include a program or movie identifier, a title, a subject description of the program, movie, or advertisement, a plot description, actor information, a date of production, broadcast channel, television network, artistic information, music compilations, and any other type of descriptive information about the media content. Further, the metadata can characterize a genre that describes the media content as being an advertisement, a movie, a comedy show, a sporting event, a news program, a sitcom, a talk show, an action/adventure program, or as any number of other category descriptions.

The wireless media devices 106 can include any type of device implemented to receive and/or communicate wireless data and voice communications, such as any one or combination of a mobile phone 124 (e.g., cellular, VoIP, WiFi, etc.), a portable computer device 126, a media device 128 (e.g., a personal media player, portable media player, etc.), and/or any other wireless media device that can receive media content in any form of audio, video, and/or image data. Each of the client systems 110 include a respective client device and display device 130 that together render or playback any form of audio, video, and/or image content, media content, and/or television content.

A display device 130 can be implemented as any type of a television, high definition television (HDTV), LCD, or similar display system. A client device in a client system 110 can be implemented as any one or combination of a television client device 132 (e.g., a television set-top box, a digital video recorder (DVR), etc.), a computer device 134, a gaming system 136, an appliance device, an electronic device, and/or as any other type of client device that can be implemented to receive television content or media content in any form of audio, video, and/or image data in a media content distribution system.

Any of the wireless media devices 106 and/or other media devices 108 can be implemented with one or more processors, communication components, memory components, signal processing and control circuits, and a media content rendering system. A media device may also be associated with a user or viewer (i.e., a person) and/or an entity that operates the device such that a media or client device describes logical devices that include users, software, and/or a combination of devices.

In this example, content distributor 102 includes a segmenting system 138 (e.g., any type of media content or television program segmenting system) that is implemented to segment television programs (e.g., media content 116) into program segments 140 that are maintained as recorded media content 118 and individually viewable when requested. The content distributor 102 and/or the segmenting system 138 can also associate media content metadata 122 with a particular program segment 140.

The content distributor 102 also includes an imaging system 142 that is implemented to generate scene images 144 from the program segments 140 and/or from television programs (e.g., media content 116) in any type of media content or television program imaging system. The imaging system 142 can generate the scene images 144 for display in a display bar, user interface, program guide, or other type of media content selection utility. In this example, storage media 120 stores or otherwise maintains the program segments 140 and the scene images 144 as they are generated and updated.

The segmenting system 138 and the imaging system 142 can each be implemented as computer-executable instructions and executed by processor(s) to implement the various embodiments of representative scene images as described herein. In an embodiment, the imaging system 142 can be implemented to include video encoding techniques that provide for an analysis of closed caption data to determine where advertisements are as well as where individual scenes within television media content, such as a movie or television program, begin and end. Individual frames (e.g., still images, MPEG video frames, etc.) from the television media content can be determined with image recognition techniques and stored separately from the video as the scene images 144. The individual frames can then be displayed as the scene images in a display bar, user interface, program guide, or other type of media content selection utility from which a viewer can select a television program episode for viewing.

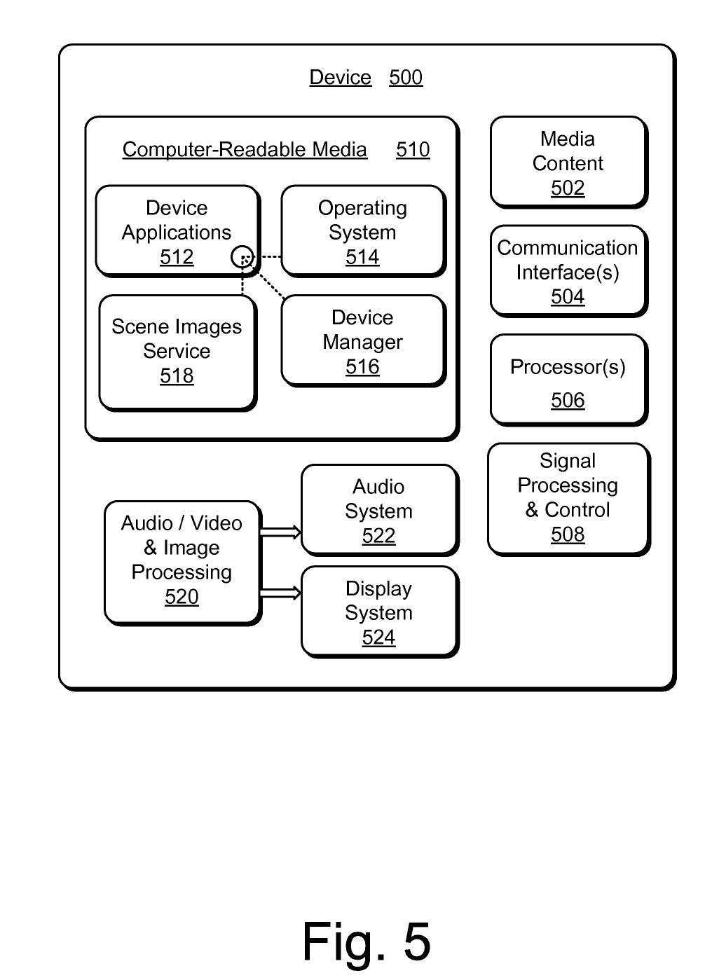

The content distributor 102 also includes a scene images service 146 that can be implemented as computer-executable instructions and executed by processor(s) to implement the various embodiments of representative scene images as described herein. Although illustrated and described as a component or module of content distributor 102, the scene images service 146, as well as other functionality to implement the various embodiments described herein, can be provided as a service apart from the content distributor 102 (e.g., on a separate server or by a third party service). In addition, content distributor 102 can be implemented with any number and combination of differing components as further described with reference to the example device shown in FIG. 5.

In one or more embodiments, the scene images service 146 can be implemented to generate an episodes user interface of scene images 144 that each represent and visually distinguish a different episode in a television program series. In an embodiment, a scene image of an episode in a television program series can be generated to best represent and/or visually identify the episode to a viewer. In this example, a media device such as television client device 132, can include a display utility and/or a user interface application to display an episodes user interface 148 on a display device 130. The scene images service 146 can initiate communication of the episodes user interface 148 to the media device to be rendered for display. The scene images in the episodes user interface 148 are then selectable by a viewer at the television client device 132 to initiate a request for an episode in the television program series to be rendered for viewing at the media device. From the scene images in the episodes user interface 148, a viewer can see what each individual episode of the television program series is about, where an episode was stopped or paused, and what programs are playing on other media devices.

A scene image 144 in an episodes user interface can include a visual context that is identifiable to represent what an episode in the television program series is about. For example, the visual context can pictorially represent the episode in the television program series. Alternatively or in addition, a scene image can include a textual description of an episode in the television program series, such as a title of the episode. Alternatively or in addition, a scene image can include a progress indicator that indicates how much of an episode in the television program series has been rendered for viewing at a media device (e.g., television client device 132). In another embodiment, a scene image of an episode in the television program series can be replaced with a suspended image that represents where a rendering of the episode is paused or stopped at the media device. In another embodiment, the episodes user interface 148 can be generated to include scene images that each visually indicate a viewing status of the different episodes in the television program series at the media device.

In other embodiments, a user interface can also be generated to include scene images that each represent and visually distinguish a group of related media content, such as photograph collections or viewer-generated media content. The scene images in the user interface can be viewer-selectable, and any group of the related media content, photograph collection, or viewer-generated media content can be selected to initiate rendering the selected media content for viewing.

In other embodiments, a user interface of scene images can be implemented as a common user interface across a system and/or family of media devices to provide a common user interface experience (also referred to as a common “user experience”) across all of the media devices. This simplifies the user experience for users that have multiple devices for media content, such as movies, videos, music, and photos. A common user interface of scene images can be scaled for display on any of various media devices, such as a personal media player, a display device for a television client device, a portable communication device (e.g., a cellular phone, PDA, and/or combination media player), a computing-based device such as a desktop computer or portable computer, and/or as any other type of media device. In addition to a common user experience, a common user interface structure provides a seamless transition, such as when a user switches between the various media devices to playback or render the same media content.

In other embodiments, a user interface of scene images can be utilized to display which episodes in a television program series are popular across a social network or viewing community associated with a particular viewer. When viewing a community Web page, for example, representative scene images or still frames can be displayed for members of a social network and/or for the most popular programs.

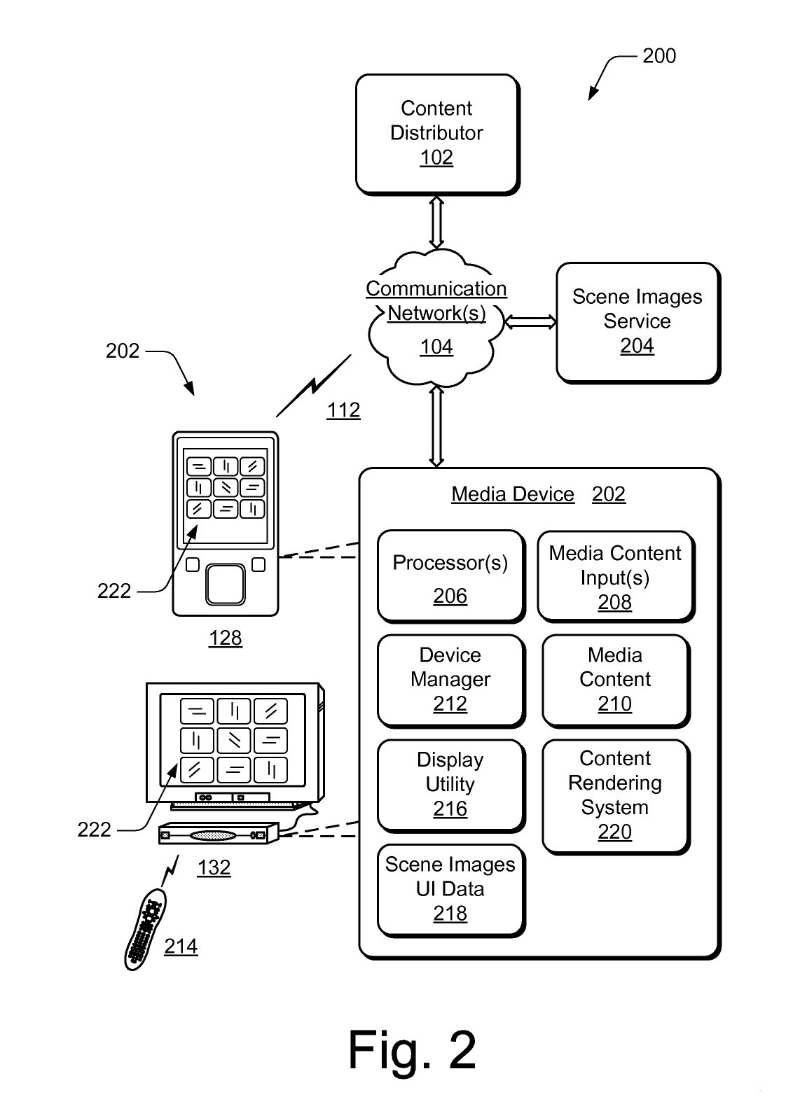

FIG. 2 illustrates an example system 200 in which various embodiments of representative scene images can be implemented. In this example, system 200 includes the content distributor 102 and examples of wired and/or wireless media devices 202, such as portable media device 128 and television client device 132 as described with reference to FIG. 1. System 200 also includes an example of a scene images service 204 that can be implemented as an independent component of system 200, and which implements the various embodiments of representative scene images as described herein. The content distributor 102, media devices 202, and the scene images service 204 can all be implemented for communication with each other via the communication network(s) 104 and/or the wireless communications network 112.

In this example, the scene images service 204 is independent and implemented apart from content distributor 102 (e.g., on a separate server or by a third party service), and in an embodiment, can be implemented as a subscription-based service. Alternatively, the scene images service 204 can be implemented as a component or service of the content distributor 102 as described with reference to FIG. 1.

The media devices 202 can be implemented with processing, communication, and memory components, as well as signal processing and control circuits. A media device 202 may also be associated with a user or owner (i.e., a person) and/or an entity that operates the device such that a media device describes logical devices that include users, software, and/or a combination of devices. In this example, the media device 202 includes one or more processors 206 (e.g., any of microprocessors, controllers, and the like), media content inputs 208, and media content 210 (e.g., received media content, media content that is being received, recommended media content, recorded media content, etc.). The media content inputs 208 can include any type of wireless, broadcast, and/or over-the-air inputs via which media content is received.

Media device 202 can also include a device manager 212 (e.g., a control application, software application, signal processing and control module, etc.) that can be implemented as computer-executable instructions and executed by the processors 206 to implement various embodiments and/or features of representative scene images as described herein. The device manager 212 can be implemented to monitor and/or receive selectable inputs (e.g., viewer selections, navigation inputs, etc.) via an input device 214, and initiate communication of viewer selections back to content distributor 102 and/or to the scene images service 204.

Media device 202 can also include a display utility 216 (e.g., a user interface application) that can be implemented to process user interface data 218 received from content distributor 102 and/or from the scene images service 204. A content rendering system 220 can render to display an episodes user interface 222 for viewing at a media device 202. A media device 202 can display the various types of media content 210, as well as the episodes user interface 222. A viewer can interact with a media device 202 and initiate viewer navigation inputs and selections of a scene image from the episodes user interface 222 with user inputs, such as on the portable media device 128 or with the remote control input device 214.

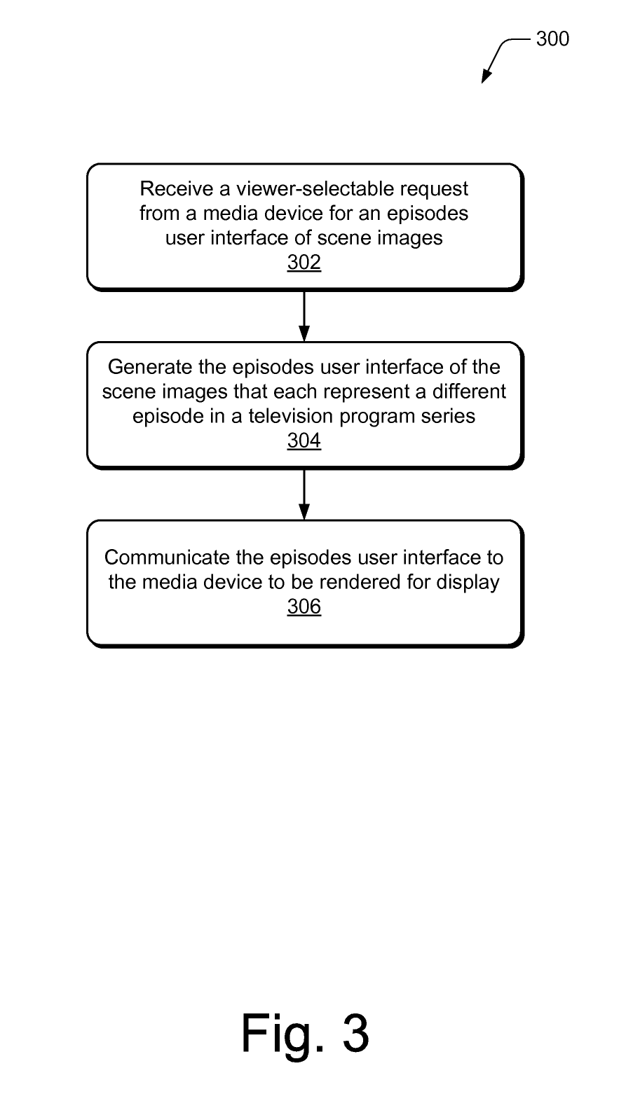

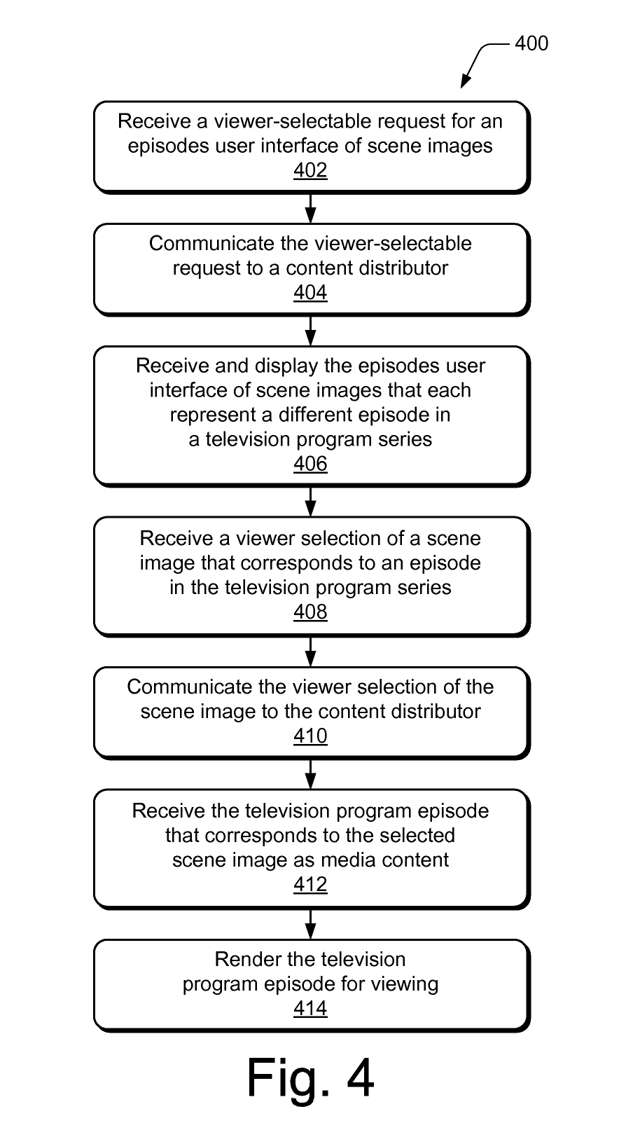

Example methods 300 and 400 are described with reference to respective FIGS. 3 and 4 in accordance with one or more embodiments of representative scene images. Generally, any of the functions, methods, procedures, components, and modules described herein can be implemented using hardware, software, firmware, fixed logic circuitry, manual processing, or any combination thereof. A software implementation of a function, method, procedure, component, or module represents program code that performs specified tasks when executed on a computing-based processor. Example methods 300 and 400 may be described in the general context of computer-executable instructions. Generally, computer-executable instructions can include software, applications, routines, programs, objects, components, data structures, procedures, modules, functions, and the like.

The method(s) may also be practiced in a distributed computing environment where functions are performed by remote processing devices that are linked through a communication network. In a distributed computing environment, computer-executable instructions may be located in both local and remote computer storage media, including memory storage devices. Further, the features described herein are platform-independent such that the techniques may be implemented on a variety of computing platforms having a variety of processors.

FIG. 3 illustrates example method(s) 300 of representative scene images, and is described with reference to a content distributor and/or a scene images service. The order in which the method is described is not intended to be construed as a limitation, and any number of the described method blocks can be combined in any order to implement the method, or an alternate method.

At block 302, a viewer-selectable request from a media device for an episodes user interface of scene images is received. For example, the scene images service 146 at content distributor 102 (FIG. 1) receives a request for an episodes user interface 148 of scene images 144 when initiated by a viewer at television client device 132. At block 304, an episodes user interface is generated to include the scene images that each represent a different episode in a television program series. For example, the scene images service 146 generates the episodes user interface 148 of the scene images 144.

In various embodiments, each of the scene images 144 represent and visually distinguish an episode in the television program series. A scene image can include a visual context that is identifiable to represent what the episode in the television program series is about. A scene image can also include a textual description of the episode in the television program series, such as a title of the particular episode. A scene image can also include a progress indicator that indicates how much of the episode in the television program series has been rendered for viewing at the television client device 132. A scene image of the episode in the television program series can be replaced with a suspended image that represents where a rendering of the episode is paused or stopped. The episodes user interface 148 may also be generated to include the scene images 144 that each visually indicate a viewing status of the different episodes in the television program series at a media device and/or at a group of media devices.

At block 306, the episodes user interface is communicated to the media device to be rendered for display. For example, the scene images service 146 initiates communication of the episodes user interface 148 to television client device 132 via which the request for the episodes user interface is initiated. In an embodiment, the scene images are selectable via the episodes user interface 148 to initiate a request for an episode in the television program series to be rendered for viewing at the media device.

FIG. 4 illustrates example method(s) 400 of representative scene images, and is described with reference to a media device, such as a television client device. The order in which the method is described is not intended to be construed as a limitation, and any number of the described method blocks can be combined in any order to implement the method, or an alternate method.

At block 402, a viewer-selectable request for an episodes user interface of scene images is received. For example, a viewer at television client device 132 initiates a command or request for an episodes user interface 148 of scene images 144. At block 404, the viewer-selectable request is communicated to a content distributor. For example, the television client device 132 communicates the viewer-selectable request for the episodes user interface 148 to content distributor 102. The request is received at the scene images service 146 that generates the episodes user interface 148 of the scene images 144.

At block 406, the episodes user interface is received and displayed to include the scene images that each represent a different episode in a television program series. For example, the television client device 132 receives and renders the episodes user interface 148. At block 408, a viewer selection of a scene image that corresponds to an episode in the television program series is received. For example, a viewer at television client device 132 initiates a selection of a scene image that corresponds to an episode in the television program series. At block 410, the viewer selection of the scene image is communicated to the content distributor. For example, the television client device 132 communicates the selection to content distributor 102 as a request for the media content (e.g., the television program episode that corresponds to the selected scene image).

At block 412, the television program episode that corresponds to the selected scene image is received as media content. For example, the television client device 132 receives the television program episode (e.g., media content 116) from content distributor 102. At block 414, the television program episode is rendered for viewing. For example, the television client device 132 renders the television program episode for viewing on display device 130.

FIG. 5 illustrates various components of an example device 500 that can be implemented as any form of a mobile communication, computing, electronic, and/or media device to implement various embodiments of representative scene images. For example, device 500 can be implemented as a computer device, server device, television client device, an independent scene images service, and/or a content distributor as shown in FIG. 1 and/or FIG. 2.

Device 500 includes media content 502 and one or more communication interfaces 504 that can be implemented for any type of data and/or voice communication via communication network(s). Device 500 also includes one or more processors 506 (e.g., any of microprocessors, controllers, and the like) which process various computer-executable instructions to control the operation of device 500, and to implement embodiments of representative scene images. Alternatively or in addition, device 500 can be implemented with any one or combination of hardware, firmware, or fixed logic circuitry that is implemented in connection with signal processing and control circuits which are generally identified at 508.

Device 500 also includes computer-readable media 510, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), any type of a digital versatile disc (DVD), and the like.

Computer-readable media 510 provides data storage mechanisms to store the media content 502, as well as various device applications 512 and any other types of information and/or data related to operational aspects of device 500. For example, an operating system 514 can be maintained as a computer application with the computer-readable media 510 and executed on the processors 506. The device applications 512 can also include a device manager 516 and a scene images service 518. In this example, the device applications 512 are shown as software modules and/or computer applications that can implement various embodiments of representative scene images as described herein.

Device 500 can also include an audio, video, and/or image processing system 520 that provides audio data to an audio rendering system 522 and/or provides video or image data to an external or integrated display system 524. The audio rendering system 522 and/or the display system 524 can include any devices or components that process, display, and/or otherwise render audio, video, and image data. In an implementation, the audio rendering system 522 and/or the display system 524 can be implemented as integrated components of the example device 500. Although not shown, device 500 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Although embodiments of representative scene images have been described in language specific to features and/or methods, it is to be understood that the subject of the appended claims is not necessarily limited to the specific features or methods described. Rather, the specific features and methods are disclosed as example implementations of representative scene images.

1. A method, comprising:
generating an episodes user interface of scene images that each represent a different episode in a television program series, each of the scene images visually distinguishing an episode in the television program series; and
communicating the episodes user interface to a media device to be rendered for display, the scene images being viewer-selectable via the episodes user interface to initiate a request for an episode in the television program series to be rendered for viewing at the media device.

2. A method as recited in claim 1, further comprising receiving a viewer-selectable request via the media device for the episodes user interface of the scene images.

3. A method as recited in claim 1, wherein a scene image includes a visual context that is identifiable to represent what the episode in the television program series is about.

4. A method as recited in claim 1, wherein a scene image includes a textual description of the episode in the television program series.

5. A method as recited in claim 1, wherein a scene image includes a progress indicator that indicates how much of the episode in the television program series has been rendered for viewing at the media device.

6. A method as recited in claim 1, wherein a scene image of the episode in the television program series is replaced with a suspended image that represents where a rendering of the episode is paused or stopped.

7. A method as recited in claim 1, wherein the episodes user interface is generated to include the scene images that each visually indicate a viewing status of the different episodes in the television program series at the media device.

8. A content distributor, comprising:
an imaging system configured to generate scene images that each represent and visually distinguish a different episode in a television program series;
a scene images service configured to:
generate an episodes user interface of one or more of the scene images for the episodes in the television program series; and
initiate communication of the episode user interface to a media device to be rendered for display, the scene images being viewer-selectable via the episodes user interface to initiate a request for an episode in the television program series to be rendered for viewing at the media device.

9. A content distributor as recited in claim 8, wherein the scene images service is further configured to receive a viewer-selectable request via the media device for the episodes user interface of the one or more scene images.

10. A content distributor as recited in claim 8, wherein a scene image includes a visual context that is identifiable to represent what the episode in the television program series is about.

11. A content distributor as recited in claim 8, wherein a scene image includes a textual description of the episode in the television program series.

12. A content distributor as recited in claim 8, wherein a scene image includes a progress indicator that indicates how much of the episode in the television program series has been rendered for viewing at the media device.

13. A content distributor as recited in claim 8, wherein a scene image of the episode in the television program series is replaced with a suspended image that represents where a rendering of the episode is paused or stopped at the media device.

14. A content distributor as recited in claim 8, wherein the scene images service is further configured to generate the episodes user interface to include the scene images that each visually indicate a viewing status of the different episodes in the television program series at the media device.

15. A media device, comprising:
a display utility configured to receive and display an episodes user interface of scene images that each represent a different episode in a television program series, each of the scene images visually distinguishing an episode in the television program series; and
a content rendering system configured to receive a selected television program episode as media content via a media content input, and initiate rendering the selected television program episode for viewing.

16. A media device as recited in claim 15, wherein a scene image includes a visual context that is identifiable to represent what the episode in the television program series is about.

17. A media device as recited in claim 15, wherein a scene image includes a textual description of the episode in the television program series.

18. A media device as recited in claim 15, wherein a scene image includes a progress indicator that indicates how much of the episode in the television program series has been rendered for viewing.

19. A media device as recited in claim 15, wherein a scene image of the episode in the television program series is replaced with a suspended image that represents where a rendering of the episode is paused or stopped.

20. A media device as recited in claim 15, wherein the display utility is further configured to display the episodes user interface to include the scene images that each visually indicate a viewing status of the different episodes in the television program series.
